(19) United States
(12) Patent Application Publication
(10) Pub. No.: US 2026/0189951 A1
(43) Pub. Date: Jul. 2, 2026

(54) MEASUREMENT GAP DESIGN FOR UE THAT PERFORMS MECHANICAL BEAM STEERING FOR NON-TERRESTRIAL NETWORKS

(71) Applicant: Apple Inc., Cupertino, CA (US)

(72) Inventors: Jie Cui, San Jose, CA (US); Yang Tang, San Jose, CA (US); Chunxuan Ye, San Diego, CA (US); Qiming Li, Beijing (CN); Dawei Zhang, Saratoga, CA (US); Hong He, San Jose, CA (US); Haitong Sun, Cupertino, CA (US)

(21) Appl. No.: 18/847,946

(22) PCT Filed: Sep. 27, 2023
(86) PCT No.: PCT/CN2023/121988

§ 371 Date: Sep. 17, 2024

(51) Int. Cl. H04W 24/10; H04W 16/28

(52) U.S. Cl. CPC H04W 24/10; H04W 16/28

(57) ABSTRACT

A user equipment (UE) includes a transceiver, an antenna that is mechanically steerable by the UE and coupled with the transceiver, and a processor. The processor configured to cause the UE to receive control signaling indicating a first measurement gap configuration associated with mechanical beam steering for the antenna different from a second measurement gap configuration associated with electronic beam steering. The processor is further configured to cause the UE to communicate, while mechanically pointing toward a first direction, with a first non-terrestrial network device on a first radio frequency spectrum band, and then switch, based on the first measurement gap configuration, the antenna to mechanically point toward a second direction. The UE then performs measurements of reference signals received from a second non-terrestrial network device on a second radio frequency spectrum band.

### TECHNICAL FIELD

This application relates generally to wireless communication systems, including systems, apparatuses, and methods for measurement gap design for user equipment (UE) that performs mechanical beam steering for non-terrestrial networks.

### BACKGROUND

Wireless mobile communication technology uses various standards and protocols to transmit data between a network device (e.g., a base station, a radio head, etc.) and a wireless communication device, Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a network device of the RAN (which may also sometimes be referred to generally as a RAN node, a network node, or simply a node) and a wireless communication device known as a UE. 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the network device and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A network device used by a RAN may correspond to that RAN. One example of an E-UTRAN network device is an Evolved Universal Terrestrial Radio Access Network (E-UTRAN) Node B (also commonly denoted as evolved Node B, enhanced Node B, eNodeB, or eNB). One example of an NG-RAN network device is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example wireless communication system, according to embodiments described herein.

FIG. 2 shows an example of measurement gap configurations in a wireless communication system, according to one or more aspects described herein.

FIG. 3 shows an example method of wireless communication by a UE, according to one or more aspects described herein.

FIG. 4 shows an example method of wireless communication by a UE, according to one or more aspects described herein.

FIG. 5 shows an example method of wireless communication by a network device, according to one or more aspects described herein.

FIG. 6 illustrates an example architecture of a wireless communication system, according to embodiments described herein.

FIG. 7 illustrates an example system for performing signaling between a wireless device and a network device, according to embodiments described herein.

### DETAILED DESCRIPTION

Various embodiments are described with regard to a user equipment (UE), a non-terrestrial network (NTN) device, a network device (e.g., a terrestrial network (TN) device). However, reference to a UE is merely provided for illustrative purposes. The example embodiments may be utilized with any electronic component that may establish a connection to a network and is configured with the hardware, software, and/or firmware to exchange information and data with a network. Therefore, the UE, the NTN device, and the network device as described herein is used to represent any appropriate electronic device.

In addition to utilizing TN devices (terrestrial base stations such as an eNB or a gNB), cellular networks may use NTN devices. NIN devices may include various network devices operating above the surface of the earth that communication resources to UEs (e.g., terrestrial, airborne, or on water) with a particular coverage area served by the NTN device. For example, an appropriately configured UE that lacks coverage from a TN device may instead communicate with an NIN device. In some deployments, NTN devices are stationary relative to features on the ground, but other NTN devices move relative to the ground. Examples of stationary NTN devices include satellites in geosynchronous orbit (GSO or GEO). Examples of moving or NTN devices includes include satellites in low earth orbit (LEO) or medium earth orbit (MEO), satellites in a polar orbit, high-altitude platforms (HAPS), or drones. UEs may operate on the surface of the earth but may also operate above the surface or on water, for example on or as part of an aircraft or ship.

Network devices (whether NTN devices or TN devices) and UEs may move relative to each other during connectivity. Additionally, certain communication types (e.g., UE to NTN device communications, or terrestrially using millimeter wave communications) may benefit form using beamforming to shape the direction of electromagnetic radiation used for communication to increase distance and signal power in a particular direction. As such, UEs, including UEs that communicate with NTN devices, may use mechanical beam steering for directional antennas (e.g., parabolic antennas) or electronic beam steering for antenna arrays (e.g., grids of phased antenna array elements) to direct the energy of transmitted electromagnetic radiation or improve the reception of received electromagnetic radiation.

Additionally, in cellular networks, UEs communicating with the network may enter into or leave the coverage area of NTN devices. Such UEs need to perform various radio resource management (RRM)-related tasks to ensure continuous connectivity as the UE moves relative to the cellular network. Such RRM-related tasks include measuring neighboring cells (e.g., neighboring NTN devices) as potential target serving cells for handover from a current serving cell. For UEs in communication with TN devices (e.g., terrestrial base stations), the UE typically tunes various electrical components of the UE away from the bandwidth that the UE is using to communicate with the current serving cell to the bandwidth(s) used by neighboring cells in order to measure those neighboring cells. During such time, the UE is typically unable to receive any channel or signal from the current serving cell. Upon completion of the measurements, the UE retunes to the bandwidth of the current serving cell. In order to provide the UE time to tune, measure, then retune, the UE is configured by the network with measurement gaps where the UE does not expect or perform communications with the current serving cell. The configured measurement gap resources depend on, among other things, the capabilities of the UE and bandwidth part (BWP) used for communication, and may be periodic.

Existing measurement gap configuration and capability signaling techniques consider electronic beam steering for measurement configuration, as well as UE capability signaling, but do not effectively take into account the needs of UEs that perform mechanical beam steering to measure neighboring NTN devices, whether alone or in combination with electronic beam steering. For NTN devices, even where a neighboring NTN device is serving UEs using a same frequency carrier as a serving NTN device, the UE may need to perform mechanical beam steering to measure the neighboring NIN device, even if tuning and retuning are not needed.

Techniques for measurement gap design for mechanical beam steering in NTNs are described herein. In one or more embodiments described herein, a UE receives control signaling that indicates a measurement gap configuration for the UE that is associated with mechanical beam steering, different from a measurement gap configuration for electronic beam steering. The UE communicates in a first direction with a first NTN device on a first RF spectrum band. The UE can then use the mechanical beam steering configuration to switch an antenna of the UB that is mechanically steerable by the UE to point in a second direction of a second NTN device. The UE then performs measurements (e.g., of reference signals, such as synchronization signal blocks (SSBs)) of the second NTN device in the second direction according to the measurement gap configuration. Following measurement, the UE may mechanically beam steer back to pointing at the first NTN device to continue communication. Appropriately designed measurement gaps for NTN device measurement allow for efficient neighbor cell measurements for serving cell-related operations for UEs that use mechanical beam steering, for example, while allowing UEs measuring TN devices to utilize a different (e.g., shorter) measurement gap configuration that lessens the amount of time that the UE is unable to communicate with the current serving cell.

Techniques described herein with reference to measurement gaps may also be, be referred to, include, or apply to interruption or scheduling restriction design that impacts serving cell-related operations. Such serving cell operations may include, but are not limited to, serving cell synchronization (e.g., time and/or frequency tracking), serving cell measurement, link adaptation (e.g., channel state information (CSI) measurement and reporting, layer 1 reference signal received power (L1-RSRP) measurement and reporting), link recovery (e.g., beam failure detection (BFD), candidate beam identification (CBD)), radio link monitoring (RLM), layer 3 (L3) mobility measurements, and so on).

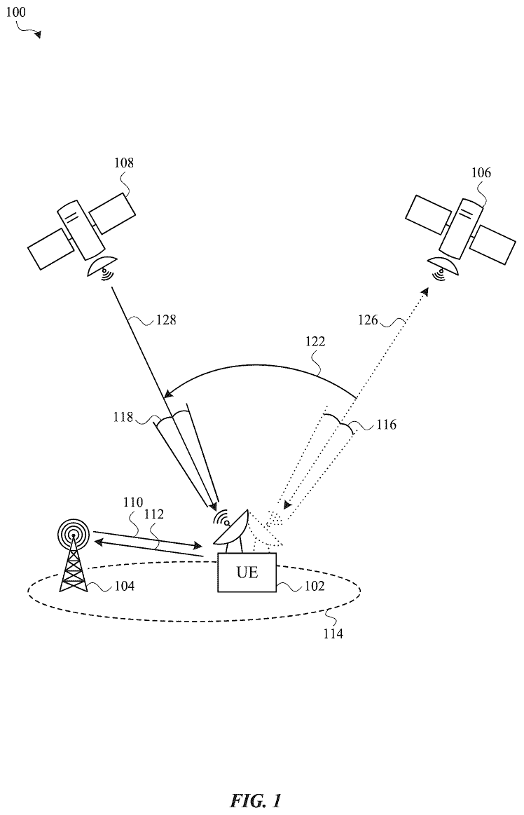

FIG. 1 shows an example wireless communication system 100, according to one or more aspects described herein. In one or more embodiments, wireless communication system 100, supports one or more aspects of measurement gap design for UE that performs mechanical beam steering for NTNs, as further described herein.

Wireless communication system 100 includes a UE 102, base station 104, NTN device 106, and NTN device 108. One or more UEs including the UE 102 may be being served by (e.g., has an established radio resource control (RRC) connection with) the NTN device 106 via communication link 126. Coverage area 114 (e.g., a cell or serving cell) is the service area for the RF spectrum band utilized by NTN device 106. In one or more embodiments, UE 102 may have previously established a connection with base station 104 (e.g., a terrestrial network (TN) device), and established a Downlink connection 110 and/or Uplink connection 112. NTN device 108 may be a neighboring NTN device to UE 102, for example having a coverage area that at least partially overlaps with coverage area 114 in some cases.

The UE 102, when pointed toward a first direction (e.g., toward NTN device 106), has a current beam that is capable of receiving signals transmitted by or transmitting signals to NTN device 106 (e.g., beam angles 116 are sufficient to cover the NTN device 106). The UE 102, when pointed toward a second direction (e.g., toward NTN device 108), has a current beam that is capable of receiving signals 128 (e.g., reference signals, such as reference or synchronization signals) transmitted by NTN device 108 (e.g., beam angles 118 are sufficient to cover the NTN device 108).

In one or more embodiments, UE 102 provides UE capability signaling to the network (e.g., to NTN device 106 via communication link 126, to base station 104 via uplink connection 112, or to another network entity), that includes an indication that the UE 102 supports mechanical beam steering. In one or more embodiments, the UE capability signaling is RRC signaling. In some embodiments, the UE capability signaling is provided to the network when the UE establishes the RRC connection with the network, or with the NTN device 106.

In some embodiments, the mechanical beam steering includes the ability of the UE 102 to mechanical move (reorient, shift, steer) one or more antennas of the UE 102 mechanically to point in various directions or range of directions.

In some embodiments, UE 102 may additionally be able to perform electronic beam steering. As used herein, electronic beam steering refers, without limitation, to the ability of a UE (e.g., UE 102) to performing beamforming, beam shaping, or other multiple antenna or multiple antenna-element techniques that control, direct, or otherwise shape electromagnetic energy radiated from the UE 102 in different directions and with different magnitudes or amplitudes. Electronic beam steering also refers to the UE 102 adjusting antennas or antenna elements to increase or decrease the ability to receive electromagnetic radiation from a particular direction. Such reception beamforming may be referred to as a “receive beam,” as opposed to transmit beamforming using “transmit beams.”

In some embodiments, the UE 102 may support mechanical beam steering, and not electronic beam steering. In one or more embodiments, the UE capability signaling transmitted by UE 102 includes an indication that the UE 102 supports mechanical beam steering, but not electronic beam steering. In one or more embodiments, the UE capability signaling transmitted by UE 102 includes an indication of one or more of a switch time, a switch period, a switch frequency (e.g., how often the beam switches), or a steering switch speed for the mechanical beam steering. In some embodiment, the beam steering switching time can be based on the size of angle change (e.g., x₁ degrees need y₁ milliseconds, but x₂ degrees need y₂ milliseconds, where x₂>x₁ and y₂>y₁.

In some embodiments, the UE 102 may support both mechanical beam steering and electronic beam steering (e.g., antenna array-based beam forming), In one or more embodiments, the UE capability signaling transmitted by UE 102 includes an indication that the UE 102 supports both electronic beam steering and mechanical beam steering. In one or more embodiments, the electronic beam steering covers a limited angular range relative to the mechanical beam steering (e.g., the mechanical beam steering can cover a greater angular area, or more sky, than the electronic beam steering). For example, if the change in the angle of arrival for NTN device 108 is larger than the angle that UE 102 can cover using electronic beam steering, then mechanical beam steering is needed. In one or more embodiments, the UE capability signaling transmitted by UE 102 includes an indication of one or more of an angle range that the electronic beam steering is able to cover (e.g., a maximum angle range). Additionally, or alternatively, the UE capability signaling includes a beam sweeping factor when electronic beam steering is used. In some embodiments, the beam sweeping factor is an integer greater than or equal to one. In one or more embodiments, the UE capability signaling transmitted by UE 102 includes an indication of one or more of a beam switch time, a beam switch period, a beam steering switch frequency (e.g., how often the beam switches), or a steering switch speed for the mechanical beam steering. In some embodiment, the beam steering switching time can be based on the size of angle change (e.g., x₁ degrees need y₁ milliseconds, but x₂ degrees need y₂ milliseconds, where x₂>x₁ and y₂>y₁.

In some embodiments, the UE 102 may support electronic beam steering, and not mechanical beam steering. In one or more embodiments, the UE capability signaling transmitted by UE 102 includes an indication that the UE 102 supports electronic beam steering, but not mechanical beam steering.

In one or more embodiments, the network indicates the measurement gap configuration to be used by UE 102. In some embodiments, the network indicates the measurement gap configuration to be used by UE 102 at least in part in response to the indication that the UE supports mechanical beam steering.

In some embodiments, the measurement gap configuration corresponds to (e.g., has a time duration equivalent to or associated with) one or more of the measurement gap configurations 200, further discussed herein. In one or more embodiments, the network (e.g., via base station 104 or NTN device 106) provides to the UE 102 an indication of a configuration for the UE 102 of a time offset for the measurement gap, a periodicity for the measurement gap, a length (duration) of the measurement gap, or a combination of these.

From the perspective of the network, the measurement gap configuration (e.g., the selection of the combination of parameters that identify the measurement gap to the UB 102) may be based on one or more of satellite ephemeris information (e.g., state information including position and velocity), position-velocity-timing (PVT) information, trajectory information, or any combination of these, or parts of these. In one or more embodiments, the network additionally or alternatively considers UE capability information provided by the UE 102, as further described herein. In one or more embodiments, the network additionally or alternatively considers location information for the UE 102. In some embodiments, the network considered one of more of these conditions (e.g., ephemeris, PVT, trajectory, UE capability, UE location information, or a combination thereof) to determine whether the measurement gap configuration for UE 102 is periodic or aperiodic.

In some embodiments, the network requests UE location information for UB 102, for example UE 102 may receive a request for such UE location information from NTN device 106 (e.g., via communication link 126), base station 104 (e.g., via Downlink connection 110) (e.g., via RRC, MAC CE, or DCI signaling). In response to the request, the UE may determine such UE location information and provide (e.g., via RRC, MAC CE, or UCI signaling) the UE location information to the network via NTN device 106 (e.g., via communication link 126), base station 104 (e.g., via Uplink connection 112). In one or more embodiments, the network may estimate the UE location information for UE 102.

In one or more embodiments, the performance of measurements by the UE 102 are aperiodic and may be triggered by the network or by UE 102 itself.

In some embodiments, the aperiodic measurements are triggered by the network or otherwise indicated to the UE 102 to perform the measurements. The network (e.g., base station 104, NTN device 106, or another network device) may determine that the NTN device 108 is not covered by the current beam of UE 102 (e.g., beam angles 116 are insufficient to cover the NTN device 108). Such determination can be based on ephemeris, PVT, trajectory, UE capability, UE location information, or a combination thereof, as further discussed above with reference to the measurement gap. In one or more embodiments, the network triggers the aperiodic measurement gap for the UE 102 to perform the measurement of NIN device 108 via DCI, MAC CE, or RRC signaling from or via NTN device 106 (e.g., using communication link 126) or base station 104 (e.g., using Downlink connection 110).

In some embodiments, the aperiodic measurements are triggered by UE 102 itself to perform the measurements.

In some embodiments, the UE 102 determines (calculates, identifies) that the NTN device 108 that is to be measured is not covered by the current beam of UE 102 (e.g., beam angles 116 are insufficient to cover the NTN device 108). Additionally, or alternatively, in some embodiments, the UE 102 determines that that NTN device 108 (e.g., the angle of arrival)) is moving out of the beam steering range of UE 102. In some embodiments, the calculations performed by UE 102 may include a margin value, such as a value of a certain amount of time (e.g., preconfigured number of milliseconds) that the NTN device 108 will go out of range (e.g., the beam steering range) of the UE 102, or that the NTN device 108 (e.g., the angle of arrival)) is approaching the edge of the beam steering range of UE 102, for example within a certain angle margin or time margin.

In some embodiments, the aperiodic measurements are triggered by UE 102. Additionally, or alternatively, the UE 102 can transmit an indication to the network (e.g., via NTN device 106 or base station 104) of the aperiodic measurement gap timing information that UE 102 is using or going to use. In some embodiments, such indication may be transmitted via DCI, MAC CE, or RRC signaling. In some embodiments, the indication may be transmitted to the network before the UE 102 performs the measurements. In other embodiments, the UE 102 transmits the indication after performing the measurements. In some embodiments, the indication may be transmitted within a time margin (e.g., threshold time) of the measurement gap, for example to take into account a scheduling processing and feedback time. For example, UE 102 may transmit the indication taking into account that the time margin between indication and the measurement gap starting point will be equal to or greater than a scheduling hybrid automatic repeat request (HARQ) feedback time to not waste scheduling from the network before the measurement gap time, for example because when the measurement gap starts, the UE 102 may not be able to communicate with the serving satellite (e.g., the NTN device 108).

In one or more embodiments, a UE 102 communicating with a NTN device 106 may use electronic beam steering, and the measurement gap is configured as long as the neighbor cell measurement (e.g., of the neighboring NTN device) is on an inter-satellite (e.g., another NTN device) even if the neighbor cell measurement (e.g., of NTN device 108) is on a same frequency carrier or bandwidth part (e.g., the same radio frequency spectrum band) as the serving cell (e.g., NTN device 106). In some embodiments, being on a same bandwidth part refers to the reference signals (e.g., SSBs) from the neighboring cell (e.g., from NIN device 108) fall within an active bandwidth part that UE 102 is using for communication with the current serving cell (e.g., NTN device 106). Otherwise, measurement without a gap may be configured. For example, if the neighbor cell measurement is intra-satellite (the neighbor cell is served by NTN device 106), and the neighbor cell is served on the same frequency carrier as the serving cell, and the neighbor cell SSB is within the serving cell's active bandwidth part.

In one or more embodiments, a UE 102 communicating with a NTN device 106 may use electronic beam steering, and a scheduling and L3 measurement restriction is assumed (e.g., by the UE 102) as long as the neighbor cell measurement (e.g., of the neighboring NTN device) is on an inter-satellite (e.g., another NTN device) even if the neighbor cell measurement (e.g., of NIN device 108) is on a same frequency carrier or bandwidth part (e.g., the same radio frequency spectrum band) as the serving cell (e.g., NTN device 106). In some embodiments, being on a same bandwidth part refers to the reference signals (e.g., SSBs) from the neighboring cell (e.g., from NTN device 108) fall within an active bandwidth part that UE 102 is using for communication with the current serving cell (e.g., NTN device 106). Otherwise, scheduling and L3 measurement is not assumed (e.g., by the UE 102). For example, if the neighbor cell measurement is intra-satellite (the neighbor cell is served by NTN device 106), and the neighbor cell is served on the same frequency carrier as the serving cell, and the neighbor cell SSB is within the serving cell's active bandwidth part. In some embodiments, the L3 measurement restriction means or refers to the UE 102 being only able to receive one reference signal from one NTN device at one time instance (e.g., where the reference signal is an SSB).

In one or more embodiments, a UE 102 communicating with a NTN device 106 may use electronic beam steering, and a synchronization signal block (SSB)-based radio resource management (RRM) measurement timing configuration (SMTC)-based interruption is assumed (e.g., by the UE 102) as long as the neighbor cell measurement (e.g., of the neighboring NTN device) is on an inter-satellite (e.g., another NTN device) even if the neighbor cell measurement (e.g., of NTN device 108) is on a same frequency carrier or bandwidth part (e.g., the same radio frequency spectrum band) as the serving cell (e.g., NTN device 106). In some embodiments, being on a same bandwidth part refers to the reference signals (e.g., SSBs) from the neighboring cell (e.g., from NTN device 108) fall within an active bandwidth part that UB 102 is using for communication with the current serving cell (e.g., NTN device 106). Otherwise, SMTC-based interruption is not assumed (e.g., by the UE 102). For example, if the neighbor cell measurement is intra-satellite (the neighbor cell is served by NTN device 106), and the neighbor cell is served on the same frequency carrier as the serving cell, and the neighbor cell SSB is within the serving cell's active bandwidth part.

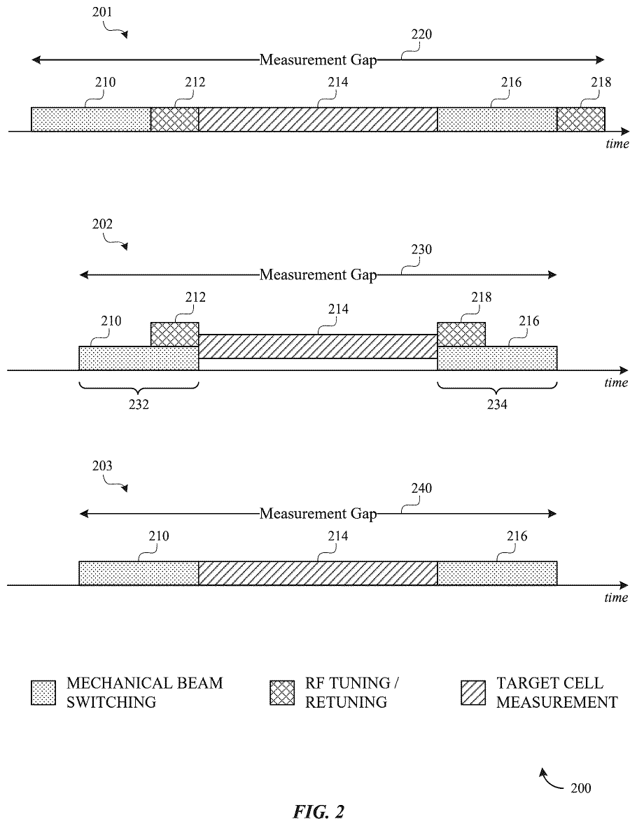

FIG. 2 shows example measurement gap configurations 200 in a wireless communication system, according to one or more aspects described herein. In one or more embodiments, measurement gap configurations 200 support one or more aspects of measurement gap design for UE that performs mechanical beam steering for NTNs, as further described herein. in a wireless communication system. Example measurement gap configurations 200 include configuration 201, configuration 202, and configuration 203, one or more of which may be used by a UE (e.g., 102) as preconfigured at the UE 102 or as configured for the UE 102 by a network via a network device (e.g., base station 104, NTN device 106, or NTN device 108) of the wireless communication system 100 that includes the UE 102. In one or more embodiments, each of measurement gap configurations 200 correspond to a single (total, amalgamated) time duration allocated for the measurement gap.

A first measurement gap configuration is configuration 201 for a measurement gap 220. In one or more embodiments, a UE may be communicating with a first NTN device using a first RF spectrum band. Configuration 201 includes five portions: a time duration 210 for a first mechanical beam steering (toward a second NTN device), a time duration 212 for radio frequency tuning (to the second RF spectrum band associated with the second NTN device), a time duration 214 for the one or more target cell measurements (of the second NTN device), a time duration 216 for a second mechanical beam steering (back to the first NTN device), and a time duration 218 for radio frequency retuning (back to the first RF spectrum band associated with the first NTN device).

A second measurement gap configuration is configuration 202 for a measurement gap 230 that includes three portions: a time duration 232, a time duration 212 for the one or more target cell measurements (of the second NTN device), and a time duration 234. The time duration 232 is a maximum time selected from a time duration 210 for a first mechanical beam steering (toward a second NTN device) and a time duration 212 for radio frequency tuning (to the second RF spectrum band associated with the second NTN device). Similarly, the time duration 234 is a maximum time selected from a time duration 216 for a first mechanical beam steering (toward a second NTN device) and a time duration 218 for radio frequency tuning (to the second RF spectrum band associated with the second NTN device).

A third measurement gap configuration is configuration 203 for a measurement gap 230 that includes three portions: a time duration 210 for a first mechanical beam steering (toward a second NTN device), a time duration 214 for the one or more target cell measurements (of the second NTN device), and a time duration 216 for a second mechanical beam steering (back to the first NTN device). In one or more embodiments, if needed, the UE may perform the radio frequency tuning (to the second RF spectrum band associated with the second NTN device) in parallel with or during time duration 210. Similarly, the on one or more embodiments, if needed, the UE may perform the radio frequency retuning (back to the first RF spectrum band associated with the first NTN device) in parallel with or during time duration 216.

In one or more embodiments, the duration (length) of the time duration 214 for the target cell measurements may be an effective measurement time, for example an integer number, sufficient for the measurements. In one or more embodiments, the time duration 210 and the time duration 216 may be an effective mechanical beam steering time for the mechanical antenna components of UE 102, for example a slowest (longest) time required for the UE 102 to move from a first position to a second position, as further described herein. In one or more embodiments, the time duration 212 and the time duration 218 may be an effective tuning or retuning time for the UE 102, and may be based on a typical, average, or other value selected to allow the UE 102 adequate time to tune between RF spectrum bands to perform the target cell measurements.

In one or more embodiments, the measurement gap has a different total length or length (time duration) based on whether radio frequency tuning or retuning is to be performed (e.g., in addition to mechanical beam steering), to perform the measurements. In some embodiments, radio frequency tuning or retuning may only be needed when the measurement object is not contained in (e.g., outside) the currently active bandwidth part (BWP). For example, if the first radio frequency spectrum band is within a first BWP and the second radio frequency spectrum band is outside of the first BWP, radio frequency tuning and retuning may be needed. Put another way, in some embodiments, intra-frequency measurements may use a different measurement gap configuration (e.g., a different length or duration of measurement gap) than inter-frequency measurements. In one or more embodiments, if radio frequency tuning is not going to be performed, the measurement gap may be according to configuration 203, as further discussed above. However, if radio frequency tuning is going to be performed, the measurement gap may be according to a different configuration of measurement gap configurations 200 (e.g., one of configuration 201, configuration 202, or configuration 203).

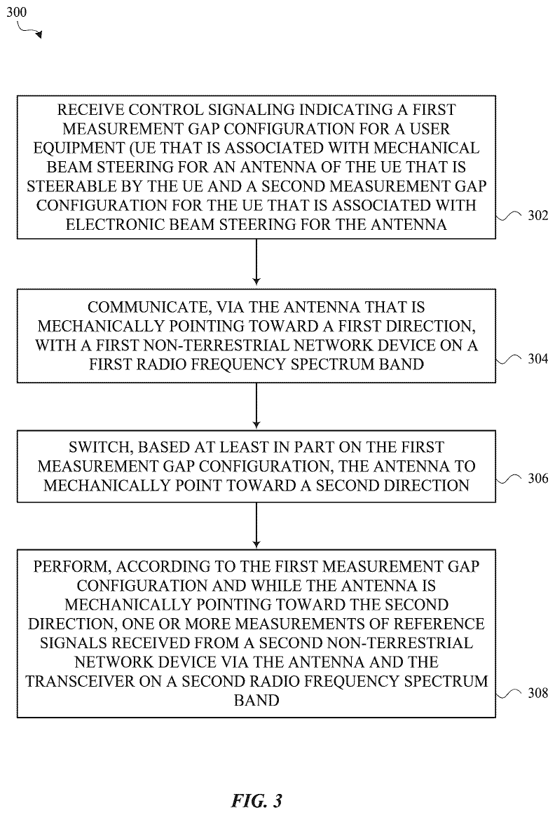

FIG. 3 shows an example method 300 of wireless communication by a UE. In one or more embodiments, method 300, supports one or more aspects of measurement gap design for UE that performs mechanical beam steering for NTNs, as further described herein. In some cases, the UE may be the UE 102, wireless device 702, or one of the other UEs or wireless devices described herein. The method 300 may be performed using a processor, a transceiver (or a main radio), or other components of the UE.

At 302, the method 300 includes receiving, via a transceiver of the UE, control signaling indicating a first measurement gap configuration for the UE that is associated with mechanical beam steering for an antenna of the UE that is mechanically steerable by the UB and a second measurement gap configuration for the UE that is associated with electronic beam steering for the antenna.

At 304, the method 300 includes communicating, via the antenna that is mechanically pointing toward a first direction, with a first non-terrestrial network device on a first radio frequency spectrum band.

At 306, the method 300 includes switching, based at least in part on the first measurement gap configuration, the antenna to mechanically point toward a second direction.

At 308, the method 300 includes performing, according to the first measurement gap configuration and while the antenna is mechanically pointing toward the second direction, one or more measurements of reference signals received from a second non-terrestrial network device via the antenna and the transceiver on a second radio frequency spectrum band.

The method 400 may be variously embodied, extended, or adapted, as described in the following paragraphs and elsewhere in this description.

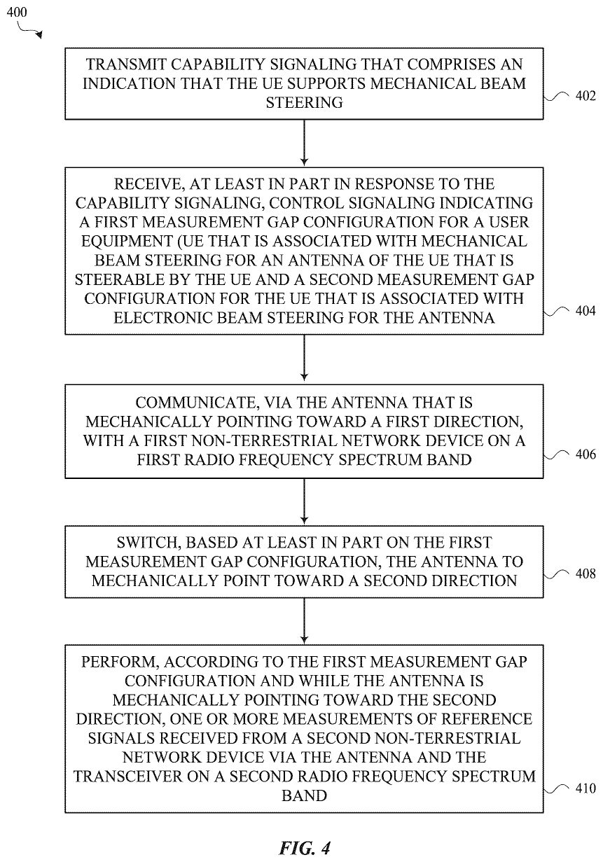

FIG. 4 shows an example method 400 of wireless communication by a UE. In one or more embodiments, method 400, supports one or more aspects of measurement gap design for UE that performs mechanical beam steering for NTNs, as further described herein. In some cases, the UE may be the UE 102, wireless device 702, or one of the other UEs or wireless devices described herein. The method 400 may be performed using a processor, a transceiver (or a main radio), or other components of the UE.

At 402, the method 400 includes transmitting capability signaling that includes an indication that the UE supports mechanical beam steering.

At 404, the method 400 includes receiving, at least in part in response to the capability signaling, control signaling indicating a first measurement gap configuration and a second measurement gap configuration. The first measurement gap configuration is for a UE that is associated with mechanical beam steering for an antenna of the UE that is mechanically steerable by the UE. The second measurement gap configuration for the UB is associated with electronic beam steering for an antenna of the UE.

At 406, the method 400 includes communicating, via the antenna that is mechanically pointing toward a first direction, with a first non-terrestrial network device on a first radio frequency spectrum band.

At 408, the method 400 includes switching, based at least in part on the first measurement gap configuration, the antenna to mechanically point toward a second direction.

At 410, the method 400 includes performing, according to the first measurement gap configuration and while the antenna is mechanically pointing toward the second direction, one or more measurements of reference signals received from a second non-terrestrial network device via the antenna and the transceiver on a second radio frequency spectrum band.

The method 400 may be variously embodied, extended, or adapted, as described in the following paragraphs and elsewhere in this description.

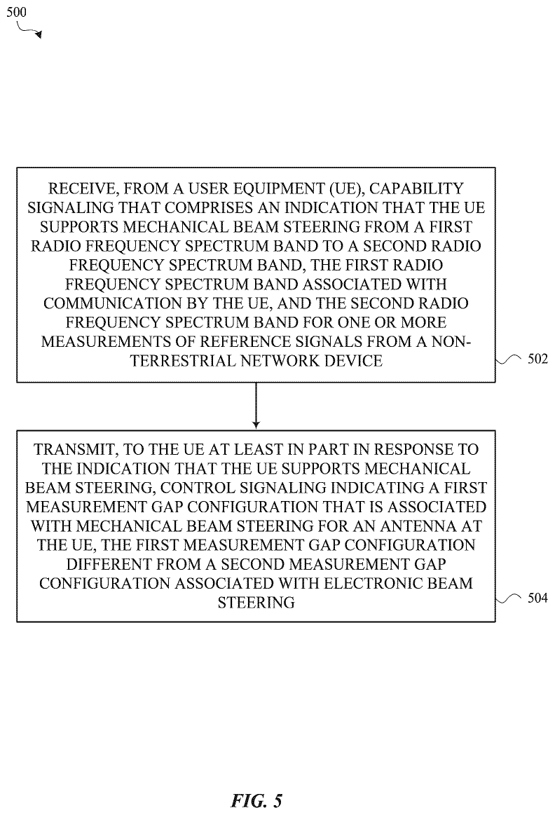

FIG. 5 shows an example method 500 of wireless communication by a network device. In one or more embodiments, method 500, supports one or more aspects of measurement gap design for UE that performs mechanical beam steering for NTNs, as further described herein. In some cases, the network device may be the base station 104, network device 720, NTN device 740, or one of the other base stations or network devices described herein. The method 500 may be performed using a processor, a transceiver (or main radio), or other components of the network device.

At 502, the method 500 includes receiving, from a UE, capability signaling that includes an indication that the UE supports mechanical beam steering from a first radio frequency spectrum band to a second radio frequency spectrum band. The first radio frequency spectrum band is associated with communication by the UE. The second radio frequency spectrum band is for one or more measurements of reference signals from a non-terrestrial network device.

At 504, the method 500 includes transmitting, to the UE at least in part in response to the indication that the UE supports mechanical beam steering, control signaling indicating a first measurement gap configuration that is associated with mechanical beam steering for an antenna at the UE. The first measurement gap configuration is different from a second measurement gap configuration associated with electronic beam steering.

Embodiments contemplated herein include one or more non-transitory computer-readable media storing instructions to cause an electronic device, upon execution of the instructions by one or more processors of the electronic device, to perform one or more elements of the method 300, 400, or 500. In the context of method 300 or 400, this non-transitory computer-readable media may be, for example, a memory of a UE (such as a memory 706 of a wireless device 702 that is a UE, as described herein). In the context of method 500, this non-transitory computer-readable media may be, for example, a memory of a network device (such as a memory 724 of a network device 720, as described herein).

Embodiments contemplated herein include an apparatus having logic, modules, or circuitry to perform one or more elements of the method 300, 400, or 500. In the context of method 300 or 400, this apparatus may be, for example, an apparatus of a UE (such as a wireless device 702 that is a UE). In the context of method 500, this apparatus may be, for example, an apparatus of a network device (such as a network device 720, as described herein).

Embodiments contemplated herein include an apparatus having one or more processors and one or more computer-readable media, using or storing instructions that, when executed by the one or more processors, cause the one or more processors to perform one or more elements of the method 300, 400, or 500. In the context of method 300 or 400, this apparatus may be, for example, an apparatus of a UE (such as a wireless device 702 that is a UE, as described herein). In the context of the method 500, this apparatus may be, for example, an apparatus of a network device (such as a network device 720, as described herein).

Embodiments contemplated herein include a signal as described in or related to one or more elements of the method 300, 400, or 500.

Embodiments contemplated herein include a computer program or computer program product having instructions, wherein execution of the program by a processor causes the processor to carry out one or more elements of the method 300, 400, or 500. In the context of method 300 or 400, the processor may be a processor of a UE (such as a processor(s) 704 of a wireless device 702 that is a UE, as described herein), and the instructions may be, for example, located in the processor and/or on a memory of the UE (such as a memory 706 of a wireless device 702 that is a UE, as described herein). In the context of method 500, the processor may be a processor of a network device (such as a processor(s) 722 of a network device 720, as described herein), and the instructions may be, for example, located in the processor and/or on a memory of the network device (such as a memory 724 of a network device 720, as described herein).

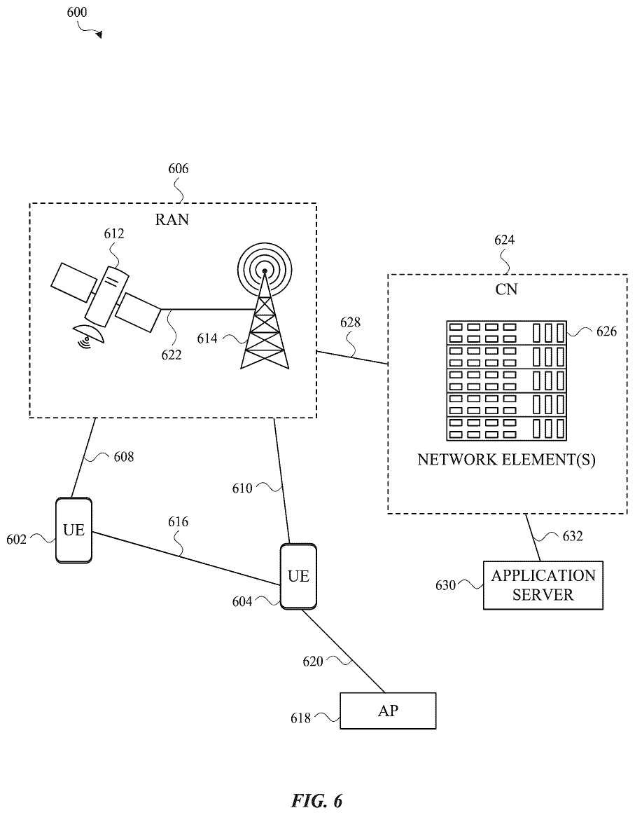

FIG. 6 illustrates an example architecture of a wireless communication system, according to embodiments described herein. The following description is provided for an example wireless communication system 600 that operates in conjunction with the LTE system standards or specifications and/or 5G or NR system standards or specifications, as provided by 3GPP technical specifications.

As shown by FIG. 6, the wireless communication system 600 includes UE 602 and UE 604 (although any number of UEs may be used). In this example, the UE 602 and the UE 604 are illustrated as smartphones (e.g., handheld touchscreen mobile computing devices connectable to one or more cellular networks) but may also comprise any mobile or non-mobile computing device configured for wireless communication.

The UE 602 and UE 604 may be configured to communicatively couple with a RAN 606. In embodiments, the RAN 606 may be NG-RAN, E-UTRAN, etc. The UE 602 and UE 604 utilize connections (or channels) (shown as connection 608 and connection 610, respectively) with the RAN 606, each of which comprises a physical communications interface. The RAN 606 can include one or more network devices, such as base station 612 and base station 614 that enable the connection 608 and connection 610. In embodiments, base station 612 is a TN device. In other embodiments, base station 612 is an NIN device that may itself be configured as a base station (e.g., an eNB or gNB), or may be a relay, providing a connection for UE with a ground station (e.g., a terrestrial base station) via the NTN device, or a combination of these.

In this example, the connection 608 and connection 610 are air interfaces to enable such communicative coupling and may be consistent with RAT(s) used by the RAN 606, such as, for example, an LTE and/or NR.

In some embodiments, the UE 602 and UE 604 may also directly exchange communication data via a sidelink interface 616. The UE 604 is shown to be configured to access an access point (shown as AP 618) via connection 620. By way of example, the connection 620 can comprise a local wireless connection, such as a connection consistent with any IEEE 802.11 protocol, wherein the AP 618 may comprise a Wi-Fi® router. In this example, the AP 618 may be connected to another network (for example, the Internet) without going through a CN 624.

In embodiments, the UE 602 and UE 604 can be configured to communicate using orthogonal frequency division multiplexing (OFDM) communication signals with each other or with the base station 612 and/or the base station 614 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 612 or base station 614 may be implemented as one or more software entities running on server computers as part of a virtual network. In addition, or in other embodiments, the base station 612 or base station 614 may be configured to communicate with one another via interface 622. In embodiments where the wireless communication system 600 is an LTE system (e.g., when the CN 624 is an EPC), the interface 622 may be an X2 interface. The X2 interface may be defined between two or more network devices of a RAN (e.g., two or more eNBs and the like) that connect to an EPC, and/or between two eNBs connecting to the EPC. In embodiments where the wireless communication system 600 is an NR system (e.g., when CN 624 is a 5GC), the interface 622 may be an Xn interface. The Xn interface is defined between two or more network devices of a RAN (e.g., two or more gNBs and the like) that connect to the 5GC, between a base station 612 (e.g., a gNB) connecting to the 5GC and an eNB, and/or between two eNBs connecting to the 5GC (e.g., CN 624).

The RAN 606 is shown to be communicatively coupled to the CN 624. The CN 624 may comprise one or more network elements 626, which are configured to offer various data and telecommunications services to customers/subscribers (e.g., users of UE 602 and UE 604) who are connected to the CN 624 via the RAN 606. The components of the CN 624 may be implemented in one physical device or separate physical devices including components to read and execute instructions from a machine-readable or computer-readable medium (e.g., a non-transitory machine-readable storage medium).

In embodiments, the CN 624 may be an EPC, and the RAN 606 may be connected with the CN 624 via an S1 interface 628. In embodiments, the S1 interface 628 may be split into two parts, an S1 user plane (S1-U) interface, which carries traffic data between the base station 612 or base station 614 and a serving gateway (S-GW), and the S1-MME interface, which is a signaling interface between the base station 612 or base station 614 and mobility management entities (MMEs).

In embodiments, the CN 624 may be a 5GC, and the RAN 606 may be connected with the CN 624 via an NG interface 628. In embodiments, the NG interface 628 may be split into two parts, an NG user plane (NG-U) interface, which carries traffic data between the base station 612 or base station 614 and a user plane function (UPF), and the S1 control plane (NG-C) interface, which is a signaling interface between the base station 612 or base station 614 and access and mobility management functions (AMFs).

Generally, an application server 630 may be an element offering applications that use internet protocol (IP) bearer resources with the CN 624 (e.g., packet switched data services). The application server 630 can also be configured to support one or more communication services (e.g., VoIP sessions, group communication sessions, etc.) for the UE 602 and UE 604 via the CN 624. The application server 630 may communicate with the CN 624 through an IP communications interface 632.

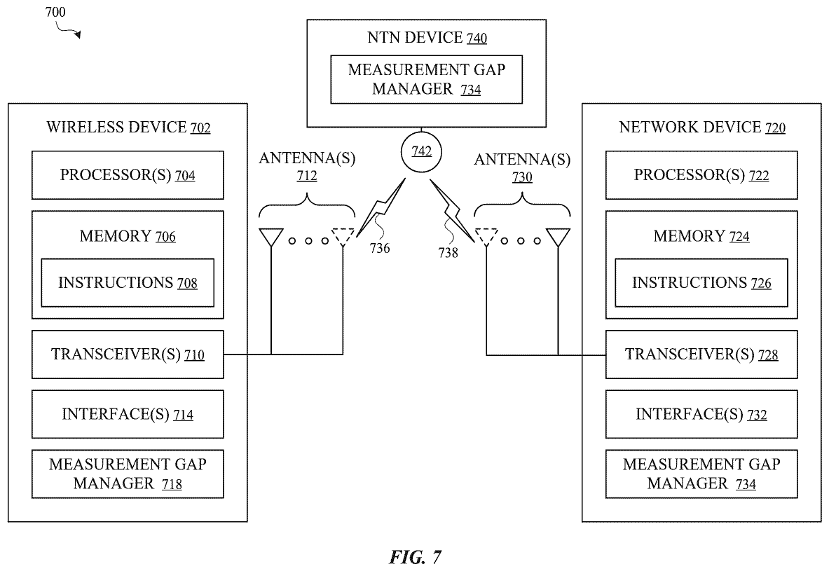

FIG. 7 illustrates an example system 700 for performing the signaling 736 and the signaling 738 between a wireless device 702 and a network device 720, according to embodiments described herein. The system 700 may be a portion of a wireless communication system as herein described. The wireless device 702 may be, for example, a UE of a wireless communication system. The network device 720 may be, for example, a base station (e.g., an eNB or a gNB) or a radio head of a wireless communication system. The NTN device 740 may communicate via one or more antennas 742 and may be, for example, an example of a base station (e.g., an eNB or a gNB) or a relay of the wireless communication system that communicates with a terrestrial ground base station.

The wireless device 702 may include one or more processor(s) 704. The processor(s) 704 may execute instructions such that various operations of the wireless device 702 are performed, as described herein. The processor(s) 704 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 702 may include a memory 706. The memory 706 may be a non-transitory computer-readable storage medium that stores the instructions 708 (which may include, for example, the instructions being executed by the processor(s) 704). The instructions 708 may also be referred to as program code or a computer program. The memory 706 may also store data used by, and results computed by, the processor(s) 704.

The wireless device 702 may include one or more transceiver(s) 710 (also collectively referred to as a transceiver 710) that may include RF (RF) transmitter and/or receiver circuitry that use the antenna(s) 712 of the wireless device 702 to facilitate signaling (e.g., the signaling 738) to and/or from the wireless device 702 with other devices (e.g., the network device 720) according to corresponding RATs.

The wireless device 702 may include one or more antenna(s) 712 (e.g., one, two, four, eight, or more). For embodiments with multiple antenna(s) 712, the wireless device 702 may leverage the spatial diversity of such multiple antenna(s) 712 to send and/or receive multiple different data streams on the same time and frequency resources. This behavior may be referred to as, for example, MIMO behavior (referring to the multiple antennas used at each of a transmitting device and a receiving device that enable this aspect). MIMO transmissions by the wireless device 702 may be accomplished according to precoding (or digital beamforming) that is applied at the wireless device 702 that multiplexes the data streams across the antenna(s) 712 according to known or assumed channel characteristics such that each data stream is received with an appropriate signal strength relative to other streams and at a desired location in the spatial domain (e.g., the location of a receiver associated with that data stream). Some embodiments may use single user MIMO (SU-MIMO) methods (where the data streams are all directed to a single receiver) and/or multi-user MIMO (MU-MIMO) methods (where individual data streams may be directed to individual (different) receivers in different locations in the spatial domain).

In some embodiments having multiple antennas, the wireless device 702 may implement analog beamforming techniques, whereby phases of the signals sent by the antenna(s) 712 are relatively adjusted such that the (joint) transmission of the antenna(s) 712 can be directed (this is sometimes referred to as beam steering).

The wireless device 702 may include one or more interface(s) 716. The interface(s) 716 may be used to provide input to or output from the wireless device 702. For example, a wireless device 702 that is a UE may include interface(s) 716 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 710 and antenna(s) 712 already described) that allow for communication between the UE and other devices and may operate according to known protocols (e.g., Wi-Fi®, Bluetooth®, and the like).

The wireless device 702 may include measurement gap manager 718. The measurement gap manager 718 may be implemented via hardware, software, or combinations thereof. For example, the measurement gap manager 718 may be implemented as a processor, circuit, and/or instructions 708 stored in the memory 706 and executed by the processor(s) 704. In some examples, the measurement gap manager 718 may be integrated within the processor(s) 704 and/or the transceiver(s) 710. For example, the measurement gap manager 718 may be implemented by a combination of software components (e.g., executed by a DSP or a general processor) and hardware components (e.g., logic gates and circuitry) within the processor(s) 704 or the transceiver(s) 710.

The measurement gap manager 718 may be used for various aspects of the present disclosure, for example, aspects of FIGS. 1-7, from a wireless device or UE perspective. The measurement gap manager 718 (e.g., the processor(s) 704) may be configured to, for example, cause the wireless device 702 to receive, via the transceiver(s) 710, control signaling indicating a first measurement gap configuration for the wireless device 702 that is associated with mechanical beam steering for the antenna(s) 712 (e.g., an antenna that is mechanically steerable by the wireless device 702) different from a second measurement gap configuration associated with electronic beam steering (e.g., for the antenna(s) 712). The measurement gap manager 718 may be further configured to, for example, cause the wireless device 702 to communicate, via the antenna(s) 712 that is mechanically pointing toward a first direction, with a first non-terrestrial network device (e.g., NTN device 740) on a first radio frequency spectrum band. The measurement gap manager 718 may be further configured to, for example, cause the wireless device 702 to switch, based at least in part on the first measurement gap configuration, the antenna(s) 712 to mechanically point toward a second direction. The measurement gap manager 718 may be further configured to, for example, cause the wireless device 702 to perform, according to the first measurement gap configuration and while mechanically pointing toward the second direction, one or more measurements of reference signals received from a second non-terrestrial network device via the antenna(s) 712 and the transceiver(s) 712 on a second radio frequency spectrum band.

In one or more embodiments, the measurement gap manager 718 may be further configured to cause the wireless device 702 to transmit capability signaling that comprises an indication that the wireless device 702 supports mechanical beam steering, where the control signaling is received at least in part in response to the indication that the wireless device 702 supports mechanical beam steering. In some embodiments, the capability signaling includes an indication of a switch time, a switch period, a switch frequency, a steering switch speed, or any combination thereof, for the mechanical beam steering. In some embodiments, the capability signaling includes an indication of a switch time, a switch period, a switch frequency, a steering switch speed, or any combination thereof, for the mechanical beam steering. In some embodiments, the capability signaling includes or further includes an indication of an angle range, a beam sweeping factor, or both, for the electronic beam steering.

In one or more embodiments, the first measurement gap configuration includes a first time duration for radio frequency tuning, a second time duration for a first mechanical beam steering, a third time duration for the one or more measurements, a fourth time duration for a second mechanical beam steering, a fifth time duration for radio frequency retuning.

In one or more embodiments, the first measurement gap configuration includes a first time duration, a second time duration for the one or more measurements, and a third time duration for the one or more measurements, wherein the first time duration is a greater of a time duration for radio frequency tuning or a time duration for a first mechanical beam steering, and the second time duration is a greater of a time duration for radio frequency retuning or a time duration for a second mechanical beam steering.

In one or more embodiments, the first measurement gap configuration includes a first time duration for a first mechanical beam steering, a second time duration for the one or more measurements, and a third time duration for a second mechanical beam steering.

In one or more embodiments, the first radio frequency spectrum band is at least a portion of a first bandwidth part. The measurement gap manager 718 may be further configured to cause the wireless device 702 to select, based at least in part on identifying whether the wireless device 702 is to perform radio frequency tuning and radio frequency retuning to perform the one or more measurements, a first time duration or a second time duration for the first measurement gap configuration. In such case, the first time duration may be associated with the one or more measurements being performed in a second bandwidth part different from the first bandwidth part, the second time duration is associated with the one or more measurements being performed in a same bandwidth part as the first bandwidth part, and/or the first time duration is not less than the second time duration.

In one or more embodiments, the first measurement gap configuration is a time offset, a periodicity, a duration, or any combination thereof, for each measurement gap for the one or more measurements.

In one or more embodiments, the measurement gap manager 718 may be further configured to cause the wireless device 702 to receive, via the transceiver(s) 710, an aperiodic request to perform the one or more measurements. The measurement gap manager 718 (e.g., using processor(s) 704) may be configured to cause the wireless device 702 to perform the one or more measurements responsive to receiving the aperiodic request.

In one or more embodiments, the measurement gap manager 718 may be further configured to cause the wireless device 702 to identify that a trigger condition has been satisfied, and the wireless device 702 performs the one or more measurements responsive to the trigger condition being satisfied.

In one or more embodiments, the measurement gap manager 718 may be further configured to cause the wireless device 702 to switch, based at least in part on the one or more measurements having been performed, the antenna(s) 712 to mechanically point toward the first direction, and resume communicating, via the antenna(s) 712 that is mechanically pointing toward the first direction, with the first non-terrestrial network device (e.g. NTN device 740) on the radio frequency spectrum band.

In one or more embodiments, the measurement gap manager 718 may be further configured to cause the wireless device 702 to perform the one or more measurements using the first measurement gap configuration regardless of whether the first NTN device and second NTN device are using a same frequency carrier or regardless of whether the reference signals are in an active bandwidth part of the wireless device 702.

In some embodiments, the first measurement gap configuration includes an indication of a time duration for measuring SSBs from a neighboring cell of the second NTN device, during which the wireless device 702 assumes the wireless device 702 is restricted from being scheduled for communications with the first NTN device, during which the wireless device 702 assumes the wireless device 702 is restricted from performing L3 measurements of the first NTN device, during which the wireless device 702 is restricted from performing measurements of the first NTN device according to a SMTC, or any combination thereof.

The network device 720 may include one or more processor(s) 722. The processor(s) 722 may execute instructions such that various operations of the network device 720 are performed, as described herein. The processor(s) 722 may include one or more baseband processors implemented using, for example, a CPU, a DSP, an ASIC, a controller, an FPGA device, another hardware device, a firmware device, or any combination thereof configured to perform the operations described herein.

The network device 720 may include a memory 724. The memory 724 may be a non-transitory computer-readable storage medium that stores instructions 726 (which may include, for example, the instructions being executed by the processor(s) 722). The instructions 726 may also be referred to as program code or a computer program. The memory 724 may also store data used by, and results computed by, the processor(s) 722.

The network device 720 may include one or more transceiver(s) 728 (also collectively referred to as a transceiver 728) that may include RF transmitter and/or receiver circuitry that use the antenna(s) 730 of the network device 720 to facilitate signaling (e.g., the signaling 738) to and/or from the network device 720 with other devices (e.g., the wireless device 702) according to corresponding RATs.

The network device 720 may include one or more antenna(s) 730 (e.g., one, two, four, or more). In embodiments having multiple antenna(s) 730, the network device 720 may perform MIMO, digital beamforming, analog beamforming, beam steering, etc., as has been described.

The network device 720 may include one or more interface(s) 732. The interface(s) 732 may be used to provide input to or output from the network device 720. For example, a network device 720 of a RAN (e.g., a base station, a radio head, etc.) may include interface(s) 732 made up of transmitters, receivers, and other circuitry (e.g., other than the transceiver(s) 728/antenna(s) 730 already described) that enables the network device 720 to communicate with other equipment in a network, and/or that enables the network device 720 to communicate with external networks, computers, databases, and the like for purposes of operations, administration, and maintenance of the network device 720 or other equipment operably connected thereto.

The network device 720 may include at least one measurement gap manager 734. The measurement gap manager 734 may be implemented via hardware, software, or combinations thereof. For example, the measurement gap manager 734 may be implemented as a processor, circuit, and/or instructions 726 stored in the memory 724 and executed by the processor(s) 722. In some examples, the measurement gap manager 734 may be integrated within the processor(s) 722 and/or the transceiver(s) 728. For example, the measurement gap manager 734 may be implemented by a combination of software components (e.g., executed by a DSP or a general processor) and hardware components (e.g., logic gates and circuitry) within the processor(s) 722 or the transceiver(s) 728.

The measurement gap manager 734 may be used for various aspects of the present disclosure, for example, aspects of FIGS. 1-7, from a network device perspective (e.g., one or both of NTN device 740 or network device 720). The measurement gap manager 734 (e.g., the processor(s) 722) may be configured to, for example, cause the network device 720 or NTN device 740 to receive, from the wireless device 702 (e.g., a UE) (e.g., and via the transceiver(s) 728), capability signaling that includes an indication that the wireless device 702 supports mechanical beam steering from a first radio frequency spectrum band to a second radio frequency spectrum band, the first radio frequency spectrum band associated with communication by the wireless device 702, and the second radio frequency spectrum band for one or more measurements of reference signals from a non-terrestrial network device (e.g., NTN device 740). The measurement gap manager 734 may be configured to, for example, cause the network device 720 or NTN device 740 to transmit, to the wireless device 702 (e.g., the UE) (e.g., and via the transceiver(s) 728) at least in part in response to the indication that the wireless device 702 supports mechanical beam steering, control signaling indicating a first measurement gap configuration that is associated with mechanical beam steering for an antenna at the wireless device 702 (e.g., antenna(s) 712), the first measurement gap configuration different from a second measurement gap configuration associated with electronic beam steering.

In one or more embodiments, the measurement gap manager 734 may be further configured to cause the network device 720 to determine the first measurement gap configuration based at least in part on satellite ephemeris information, position information, velocity information, timing information, trajectory information, or any combination thereof, for a network device (e.g., network device 720 or NTN device 740).

In one or more embodiments, the measurement gap manager 734 may be further configured to cause the network device 720 or NTN device 740 to determine the first measurement gap configuration based at least in part on an indication of a switch time, a switch period, a switch frequency, a steering switch speed, or any combination thereof, for the mechanical beam steering, based at least in part on an indication that the wireless device 702 (e.g., a UE) supports electronic beam steering, or both.

In one or more embodiments, the measurement gap manager 734 may be further configured to cause the network device 720 or NTN device 740 to determine the first measurement gap configuration based at least in part on location information for the wireless device 702 (e.g., a UE). In some embodiments, the measurement gap manager 734 may be further configured to cause the network device 720 or NTN device 740 to transmit, to the wireless device 702 (e.g., a UE) (e.g., via the transceiver(s) 728), a request for the location information.

In one or more embodiments, the measurement gap manager 734 may be further configured to cause the network device 720 or NTN device 740 to transmit, to the wireless device 702 (e.g., a UE) (e.g., via the transceiver(s) 728), an aperiodic request for the wireless device 702 to perform the one or more measurements.

For one or more embodiments, at least one of the components set forth in one or more of the preceding figures may be configured to perform one or more operations, techniques, processes, and/or methods as set forth herein. For example, a baseband processor (or processor) as described herein in connection with one or more of the preceding figures may be configured to operate in accordance with one or more of the examples set forth herein. For another example, circuitry associated with a UE, network device, network element, etc. as described above in connection with one or more of the preceding figures may be configured to operate in accordance with one or more of the examples set forth herein.

Any of the above-described embodiments may be combined with any other embodiment (or combination of embodiments), unless explicitly stated otherwise. The foregoing description of one or more implementations provides illustration and description but is not intended to be exhaustive or to limit the scope of embodiments to the precise form described. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

The systems described herein pertain to specific embodiments but are provided as examples. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

Although the foregoing has been described in some detail for purposes of clarity, it will be apparent that changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein but may be modified within the scope and equivalents of the appended claims.

1. A user equipment (UE), comprising:
a transceiver;
an antenna that is mechanically steerable by the UE and coupled with the transceiver; and
a processor configured to cause the UE to,
receive, via the transceiver, control signaling indicating a first measurement gap configuration for the UE that is associated with mechanical beam steering for the antenna different from a second measurement gap configuration associated with electronic beam steering,
communicate, via the antenna that is mechanically pointing toward a first direction, with a first non-terrestrial network device on a first radio frequency spectrum band,
switch, based at least in part on the first measurement gap configuration, the antenna to mechanically point toward a second direction, and
perform, according to the first measurement gap configuration and while mechanically pointing toward the second direction, one or more measurements of reference signals received from a second non-terrestrial network device via the antenna and the transceiver on a second radio frequency spectrum band.

2. The UE of claim 1, wherein the processor is further configured to cause the UE to:
transmit capability signaling that comprises an indication that the UE supports mechanical beam steering, wherein the control signaling is received at least in part in response to the indication that the UE supports mechanical beam steering.

3. The UE of claim 2, wherein the capability signaling further comprises an indication of a switch time, a switch period, a switch frequency, a steering switch speed, or any combination thereof, for the mechanical beam steering.

4. The UE of claim 2, wherein the capability signaling further comprises an indication that the UE supports electronic beam steering, wherein the control signaling is received at least in part in response to both the indication that the UE supports mechanical beam steering and the indication that the UE supports electronic beam steering.

5. The UE of claim 4, wherein the capability signaling further comprises an indication of an angle range, a beam sweeping factor, or both, for the electronic beam steering.

6. The UE of claim 1, wherein the first measurement gap configuration includes a first time duration for radio frequency tuning, a second time duration for a first mechanical beam steering, a third time duration for the one or more measurements, a fourth time duration for a second mechanical beam steering, a fifth time duration for radio frequency retuning.

7. The UE of claim 1, wherein the first measurement gap configuration includes a first time duration, a second time duration for the one or more measurements, and a third time duration for the one or more measurements, wherein the first time duration is a greater of a time duration for radio frequency tuning or a time duration for a first mechanical beam steering, and the second time duration is a greater of a time duration for radio frequency retuning or a time duration for a second mechanical beam steering.

8. The UE of claim 1, wherein the first measurement gap configuration includes a first time duration for a first mechanical beam steering, a second time duration for the one or more measurements, and a third time duration for a second mechanical beam steering.

9. The UE of claim 1, wherein the first radio frequency spectrum band is at least a portion of a first bandwidth part, and the processor is further configured to:
select, based at least in part on identifying whether the UE is to perform radio frequency tuning and radio frequency retuning to perform the one or more measurements, a first time duration or a second time duration for the first measurement gap configuration, wherein the first time duration is associated with the one or more measurements being performed in a second bandwidth part different from the first bandwidth part, the second time duration is associated with the one or more measurements being performed in a same bandwidth part as the first bandwidth part, and the first time duration is not less than the second time duration.

10. The UE of claim 1, wherein the first measurement gap configuration comprises a time offset, a periodicity, a duration, or any combination thereof, for each measurement gap for the one or more measurements.

11. The UE of claim 1, wherein the processor is further configured to cause the UE to:
receive, via the transceiver, an aperiodic request to perform the one or more measurements, wherein the processor is configured to cause the UE to perform the one or more measurements responsive to receiving the aperiodic request.

12. The UE of claim 1, wherein the processor is further configured to cause the UE to:
identify that a trigger condition at the UE has been satisfied, wherein the processor is configured to cause the UE to perform the one or more measurements responsive to the trigger condition being satisfied.

13. The UE of claim 1, wherein the processor is further configured to cause the UE to:
switch, based at least in part on the one or more measurements having been performed, the antenna to mechanically point toward the first direction; and
resume communicating, via the antenna that is mechanically pointing toward the first direction, with the first non-terrestrial network device on the radio frequency spectrum band.

14. The UE of claim 1, wherein the first measurement gap configuration indicates that the UE is to:
perform the one or more measurements using the first measurement gap configuration regardless of whether the first non-terrestrial network device and second non-terrestrial network device are using a same frequency carrier or regardless of whether the reference signals are in an active bandwidth part of the UE.

15. The UE of claim 1, wherein the first measurement gap configuration comprises an indication of a time duration for measuring synchronization signal blocks from a neighboring cell of the second non-terrestrial network device, during which the UE assumes the UE is restricted from being scheduled for communications with the first non-terrestrial network device, during which the UE assumes the UE is restricted from performing layer 3 measurements of the first non-terrestrial network device, during which the UE is restricted from performing measurements of the first non-terrestrial network device according to a synchronization signal block (SSB)-based radio resource management (RRM) measurement timing configuration (SMTC), or any combination thereof.

16. A network device, comprising:
a transceiver; and
a processor configured to cause the network device to,
receive, from a user equipment (UE) and via the transceiver, capability signaling that comprises an indication that the UE supports mechanical beam steering from a first radio frequency spectrum band to a second radio frequency spectrum band, the first radio frequency spectrum band associated with communication by the UE, and the second radio frequency spectrum band for one or more measurements of reference signals from a non-terrestrial network device, and
transmit, to the UE and via the transceiver at least in part in response to the indication that the UE supports mechanical beam steering, control signaling indicating a first measurement gap configuration that is associated with mechanical beam steering for an antenna at the UE, the first measurement gap configuration different from a second measurement gap configuration associated with electronic beam steering.

17. The network device of claim 14, wherein the processor is further configured to cause the network device to:
determine the first measurement gap configuration based at least in part on satellite ephemeris information, position information, velocity information, timing information, trajectory information, or any combination thereof, for the network device.

18. The network device of claim 14, wherein the processor is further configured to cause the network device to:
determine the first measurement gap configuration based at least in part on an indication of a switch time, a switch period, a switch frequency, a steering switch speed, or any combination thereof, for the mechanical beam steering, based at least in part on an indication that the UE supports electronic beam steering, or both.

19. The network device of claim 14, wherein the processor is further configured to cause the network device to:
determine the first measurement gap configuration based at least in part on location information for the UE.

20. The network device of claim 17, wherein the processor is further configured to cause the network device to:
transmit, to the UE and via the transceiver, a request for the location information.

21. The network device of claim 14, wherein the processor is further configured to cause the network device to:
transmit, to the UE and via the transceiver, an aperiodic request for the UE to perform the one or more measurements.

22. A method of wireless communication at a user equipment (UE), comprising:
receiving, via a transceiver of the UE, control signaling indicating a first measurement gap configuration for the UE that is associated with mechanical beam steering for an antenna of the UE that is mechanically steerable by the UE and a second measurement gap configuration for the UE that is associated with electronic beam steering for the antenna;
communicating, via the antenna that is mechanically pointing toward a first direction, with a first non-terrestrial network device on a first radio frequency spectrum band;
switching, based at least in part on the first measurement gap configuration, the antenna to mechanically point toward a second direction; and
performing, according to the first measurement gap configuration and while the antenna is mechanically pointing toward the second direction, one or more measurements of reference signals received from a second non-terrestrial network device via the antenna and the transceiver on a second radio frequency spectrum band.
